(19) United States
(12) Patent Application Publication
(10) Pub. No.: US 2020/0374117 A1
(43) Pub. Date: Nov. 26, 2020

(54) METHOD FOR CREATING OR VERIFYING INPUT VALUE BY USING ASYMMETRIC ENCRYPTION ALGORITHM AND APPLICATION METHOD THEREOF

(71) Applicant: WENKO WEI, Taipei City (TW)

(72) Inventor: WENKO WEI, Taipei City (TW)

(21) Appl. No.: 16/879,805

(22) Filed: May 21, 2020

(30) Foreign Application Priority Data
May 24, 2019 (TW) 108118120

(51) Int. Cl. H04L 9/30; H04L 9/08; H04L 9/06

(52) U.S. Cl. CPC H04L 9/30; H04L 9/0618; H04L 9/0861

(57) ABSTRACT

The present invention provides a method for creating or verifying input value by using an asymmetric encryption algorithm and application method thereof. After receiving an input value (e.g. password, serial number), using the input value as a private key to generate a public key by using the asymmetric encryption algorithm, or using the input value as a seed to generate a public and private key pair by using the asymmetric encryption algorithm. Then keep the public-key and drop the private-key. When verifying an input value, repeating the above steps and comparing the new public key with the previously reserved one to determine consistency of the input values. Besides, the present invention also provides a more secure personal data protection by using the above public and private key pair, and is able to encrypt and decrypt the data by using the asymmetric encryption algorithm or symmetric key algorithm.

### CROSS-REFERENCE TO RELATED APPLICATION

This application claims the benefit of Taiwan Patent Application No. 108118120, filed on May 24, 2019, in the Taiwan Intellectual Property Office of the R.O.C, the disclosure of which is incorporated herein in its entirety by reference.

### FIELD OF INVENTION

The present invention relates to the field of information security technology and more specifically it relates to a method for creating or verifying input value by using an asymmetric encryption algorithm and application method thereof.

### BACKGROUND OF THE INVENTION

Passwords or serial numbers are mainly saved in hash value instead of plain text. Hash value of passwords or serial numbers leakage because of security breach will risk reversing to plain text by using rainbow table, and it can be avoided by extending passwords or serial numbers with an additional salt (random data) before hashing it. The salt (random data) must be kept for verification.

Brute-force method (exhaustive attack method) can crack any password or serial number, and it is only a matter of time.

Currently there are several ways that can effectively reduce the success rate of brute-force attack, e.g. limit the count of failed logins or source IP address within a limited time, never use simple passwords or serial numbers, and increase time or resource cost by using key derivation function (KDF, e.g. PBKDF2, Scrypt, Bcrypt, and ARGON2).

Any discussion of the prior art throughout the specification should in no way be considered as an admission that such prior art is widely known or forms part of common general knowledge in the field.

Besides, most of the information (e.g. personal privacy information) is usually saved in the system in plain text, and can easily leak because of system being hacked.

The above information disclosed in this section is only for enhancement of understanding of the background of the described technology and therefore it may contain information that does not form the prior art that is already known to a person of ordinary skill in the art.

### SUMMARY OF THE INVENTION

The present invention generally comprises identifying the element names within a patent document and modifying patent drawing sheets to include element names and figure descriptions.

There has thus been outlined, rather broadly, the more important features of the present invention in order that the detailed description thereof may be better understood, and in order that the present contribution to the art may be better appreciated. There are additional features of the present invention that will be described hereinafter and that will form the subject matter of the claims appended hereto.

In this respect, before explaining at least one embodiment of the invention in detail, it is to be understood that the present invention is not limited in its application to the details of construction and to the arrangements of the components set forth in the following description or illustrated in the drawings. The present invention is capable of other embodiments and of being practiced and carried out in various ways. Also, it is to be understood that the phraseology and terminology employed herein are for the purpose of the description and should not be regarded as limiting.

A primary object of the present invention is to provide a method for creating or verifying input value by using an asymmetric encryption algorithm and its application method thereof that will overcome the shortcomings of the prior art systems.

A second object of the present invention is to provide a method for creating or verifying input value by using the asymmetric encryption algorithm.

Another object of the present invention is to provide an application method for creating or verifying input value by using the asymmetric encryption algorithm, which encrypts or decrypts data by using the asymmetric encryption algorithm.

An additional object is to provide an application method for creating or verifying input value by using the asymmetric encryption algorithm, which encrypts or decrypts data using symmetric encryption algorithm.

A further object is to provide an application method for creating or verifying input value by using the asymmetric encryption algorithm, which allows a system administrator to encrypt or decrypt user's data by using a symmetric encryption algorithm.

The present invention does not only strengthen the security of current authentication methods, but also provides multiple encryption options for system users and system administrators to encrypt and decrypt dependent data. It is convenient and fast to implement, is fully compatible with current systems, does not require major system changes, can be applied to operating system authentication, network service authentication, software serial number verification and other scenarios. The privacy of system users can be protected from leakage even if the system is hacked.

Other objects and advantages of the present invention will become obvious to the reader and it is intended that these objects and advantages are within the scope of the present invention.

To the accomplishment of the above and related objects, the present invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart illustrating a first process for creating input value using the asymmetric encryption algorithm.

FIG. 2 is a flowchart illustrating a first application method of FIG. 1.

FIG. 3 is a flowchart illustrating a second application method of FIG. 1.

FIG. 4 is a flowchart illustrating a third application method of FIG. 1.

FIG. 5 is a flowchart illustrating a fourth application method of FIG. 1.

FIG. 6 is a flowchart illustrating a first process for verifying input value by using the asymmetric encryption algorithm.

FIG. 7 is a flowchart illustrating a first application method of FIG. 6.

FIG. 8 is a flowchart illustrating a second application method of FIG. 6.

FIG. 9 is a flowchart illustrating a third application method of FIG. 6.

FIG. 10 is a flowchart illustrating a fourth application method of FIG. 6.

FIG. 11 is a flowchart illustrating a second process for creating input value by using the asymmetric encryption algorithm.

FIG. 12 is a flowchart illustrating a first application method of FIG. 11.

FIG. 13 is a flowchart illustrating a second application method of FIG. 11.

FIG. 14 is a flowchart illustrating a third application method of FIG. 11.

FIG. 15 is a flowchart illustrating a fourth application method of FIG. 11.

FIG. 16 is a flowchart illustrating a second process for verifying input value by using the asymmetric encryption algorithm.

FIG. 17 is a flowchart illustrating a first application method of FIG. 16.

FIG. 18 is a flowchart illustrating a second application method of FIG. 16.

FIG. 19 is a flowchart illustrating a third application method of FIG. 16.

FIG. 20 is a flowchart illustrating a fourth application method of FIG. 16.

### DETAILED DESCRIPTION OF THE PREFERRED EMBODIMENTS

### A. Introduction

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Nowadays, companies that provide services to the public generally have all their data stored in a relational database, and passwords are mainly saved in hash value instead of plain text. Hash value of passwords leakage because of security breach will risk reversing to plain text by using rainbow table, and it can be avoided by extending passwords with an additional salt (random data) before hashing it. The salt (random data) must be kept for verification. Brute-force method (exhaustive attack method) can crack any password, and it is only a matter of time.

Currently there are several ways that can effectively reduce the success rate of brute-force attack, e.g. limit the count of failed logins or source IP address within a limited time, never use simple passwords or serial numbers, and increase time or resource cost by using key derivation function (KDF, e.g. PBKDF2, Scrypt, Bcrypt, and ARGON2).

Besides, usually most of the information (e.g. personal privacy information) is saved in the system in plain text, and can easily leak because of system being hacked.

The following descriptions are provided to elucidate a method for creating or verifying input value using asymmetric encryption algorithm and application method thereof and to aid it of skilled in the art in practicing this invention. These embodiments are merely exemplary embodiments and in no way to be considered to limit the scope of the invention in any manner.

### B. Significant Technical Features of the Present Invention

1. Hardly reversing from hash value to plain text; 2. Providing multiple encryption options for system users and system administrators to encrypt and decrypt dependent data; 3. Reducing the success rate of brute-force attack by increasing time or resource cost because of using asymmetric encryption algorithm; and 4. Fully compatible with current systems and does not require major system changes.

### C. Authentication and Data Protection

The present invention is illustrated by logging a network service system as an example:

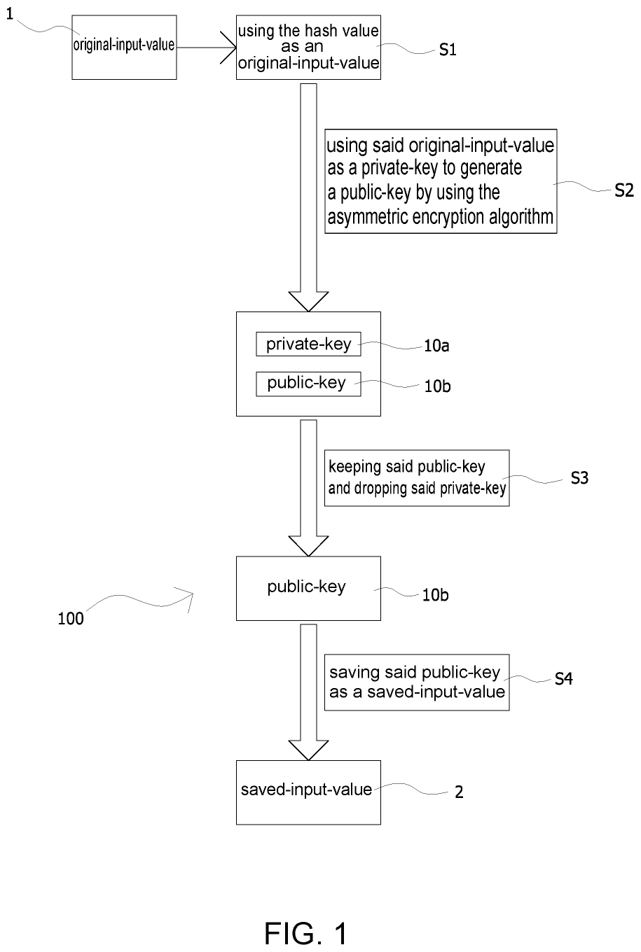

1. A First Method for Creating Password (FIG. 1, Method 100)

Please refer to FIG. 1, FIG. 1 is a flowchart illustrating the overall operation of the input value (e.g. Password) creation of the present invention. When the system user inputs the password, it has been transformed into a hash value by using the hashing algorithm (e.g. Secure Hash Algorithm). (S1) Using the hash value as an original-input-value (1); (S2) using said original-input-value (1) as a private-key (10a) to generate a public-key (10b) by using the asymmetric encryption algorithm (e.g. Elliptic Curve Cryptography); (S3) keeping said public-key (10b) and dropping said private-key (10a); and (S4) saving said public-key (10b) as a saved-input-value (2), the password (saved-input-value (2)) has been created. It is preferable that hardly reversing from hash value to plain text, fully compatible with current systems and does not require major system changes.

2. Personal Data Encryption of the First Method for Creating Password (FIG. 1, Method 100)

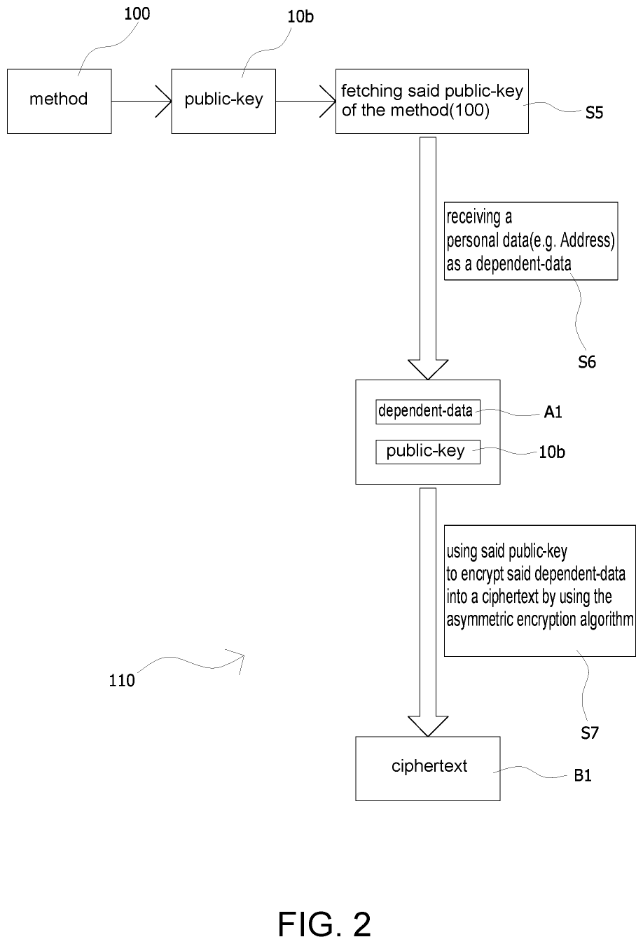

i. Using the Asymmetric Encryption Algorithm (FIG. 2, Method 110)

Please refer to FIG. 2, FIG. 2 is a flowchart illustrating the overall operation of personal data (e.g. Address) encryption of the first method for creating password (FIG. 1, method 100) of the present invention. (S5) Fetching said public-key (10b) of the first method for creating password (FIG. 1, method 100); (S6) receiving a personal data (e.g. Address) as a dependent-data (A1); and (S7) using said public-key (10b) to encrypt said dependent-data (A1) into a ciphertext (B1) by using the asymmetric encryption algorithm (e.g. Elliptic Curve Cryptography). Now, the personal data has been encrypted (ciphertext (B1)). It is preferable that the password is used as a key to encrypt personal data individually.

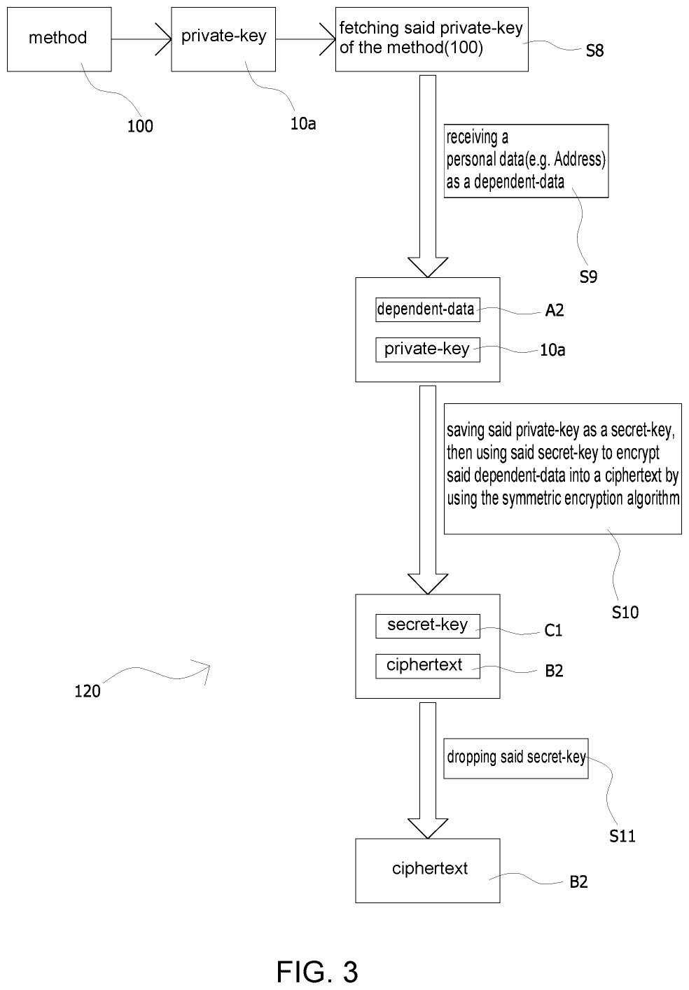

ii. Using the Symmetric Encryption Algorithm (FIG. 3, Method 120)

Please refer to FIG. 3, FIG. 3 is a flowchart illustrating the overall operation of personal data (e.g. Address) encryption of the first method for creating password (FIG. 1, method 100) of the present invention. (S8) Fetching said private-key (10a) of the first method for creating password (FIG. 1, method 100) before dropping it; (S9) receiving a personal data (e.g. Address) as a dependent-data (A2); (S10) saving said private-key (10a) as a secret-key (C1), then using said secret-key (C1) to encrypt said dependent-data (A2) into a ciphertext (B2) by using the symmetric encryption algorithm (e.g. Advanced Encryption Standard); and (S11) Dropping said secret-key (C1). Now, the personal data has been encrypted (ciphertext (B2)). It is preferable that the password is used as a key to encrypt personal data individually.

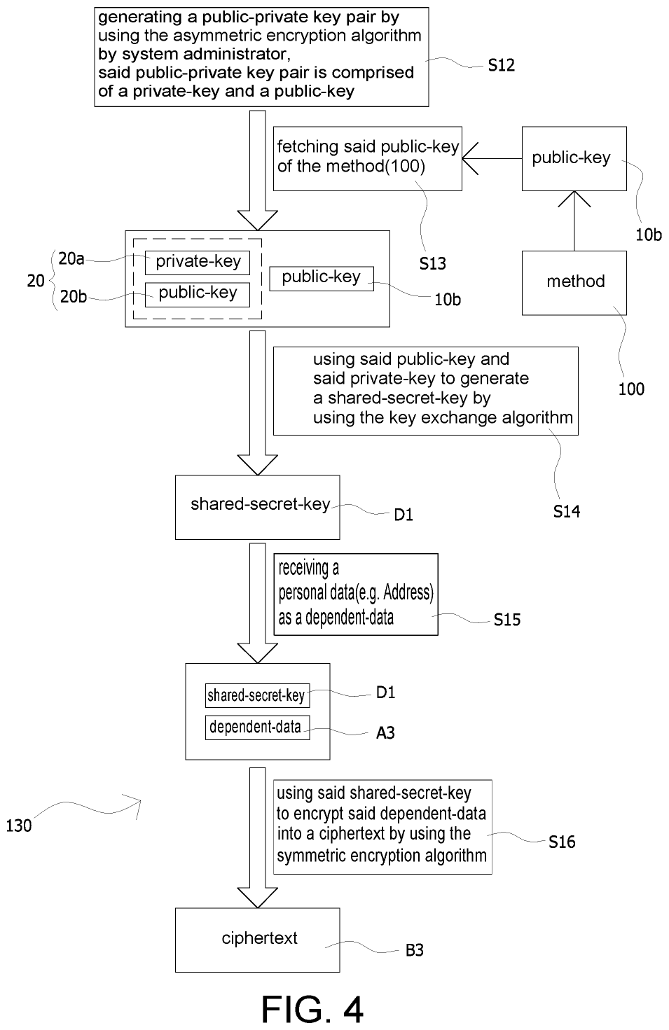

iii. A First Way to Allow System Administrators to Encrypt Personal Data (FIG. 4, Method 130)

Please refer to FIG. 4, FIG. 4 is a flowchart illustrating the overall operation of personal data (e.g. Address) encryption by system administrator of the first method for creating password (FIG. 1, method 100) of the present invention. (S12) Generating a public-private key pair (20) by using the asymmetric encryption algorithm (e.g. Elliptic Curve Cryptography) by system administrator, said public-private key pair (20) is comprised of a private-key (20a) and a public-key (20b); (S13) fetching said public-key (10b) of the first method for creating password (FIG. 1, method 100); (S14) using said public-key (10b) and said private-key (20a) to generate a shared-secret-key (D1) by using the key exchange algorithm (Diffie-Hellman key exchange); (S15) receiving a personal data (e.g. Address) as a dependent-data (A3); and (S16) using said shared-secret-key (D1) to encrypt said dependent-data (A3) into a ciphertext (B3) by using the symmetric encryption algorithm (e.g. Advanced Encryption Standard). Now, the personal data has been encrypted (ciphertext (B3)). It is preferable that both system administrator and system user can encrypt the personal data individually.

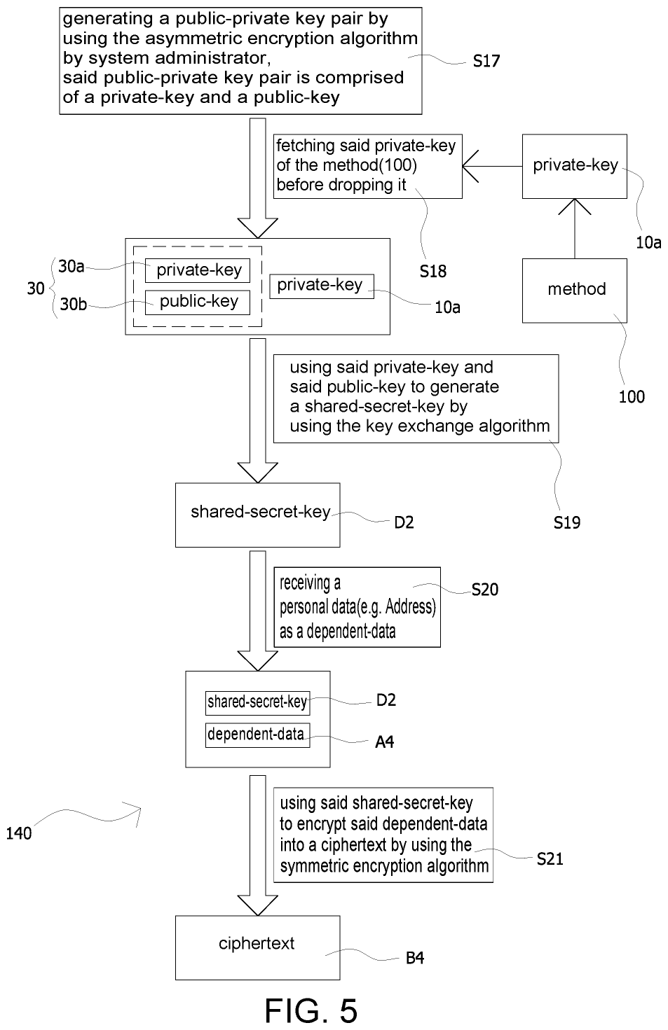

iv. A Second Way to Allow System Administrators to Encrypt Personal Data (FIG. 5, Method 140)

Please refer to FIG. 5, FIG. 5 is a flowchart illustrating the overall operation of personal data (e.g. Address) encryption by system administrator of the first method for creating password (FIG. 1, method 100) of the present invention. (S17) Generating a public-private key pair (30) by using the asymmetric encryption algorithm (e.g. Elliptic Curve Cryptography) by system administrator, said public-private key pair (30) is comprised of a private-key (30a) and a public-key (30b); (S18) fetching said private-key (10a) of the first method for creating password (FIG. 1, method 100) before dropping it; (S19) using said private-key (10a) and said public-key (30b) to generate a shared-secret-key (D2) by using the key exchange algorithm (Diffie-Hellman key exchange); (S20) receiving a personal data (e.g. Address) as a dependent-data (A4); and (S21) using said shared-secret-key (D2) to encrypt said dependent-data (A4) into a ciphertext (B4) by using the symmetric encryption algorithm (e.g. Advanced Encryption Standard). Now, the personal data has been encrypted (ciphertext (B4)). It is preferable that both system administrator and system user can encrypt the personal data individually.

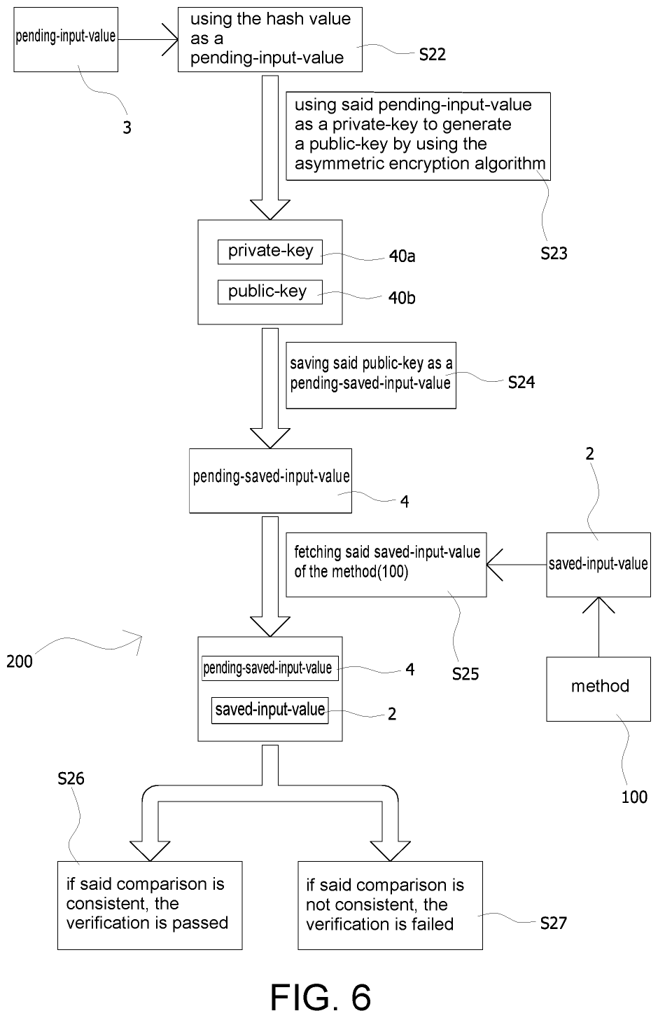

3. A First Method for Verifying Password (FIG. 6, Method 200)

Please refer to FIG. 6, FIG. 6 is a flowchart illustrating the overall operation of the input value (e.g. Password) verification of the present invention. When the system user inputs the password for verification, it has been transformed into a hash value by using the hashing algorithm (e.g. Secure Hash Algorithm). (S22) Using the hash value as a pending-input-value (3); (S23) using said pending-input-value (3) as a private-key (40a) to generate a public-key (40b) by using the asymmetric encryption algorithm (e.g. Elliptic Curve Cryptography); (S24) saving said public-key (40b) as a pending-saved-input-value (4); (S25) fetching said saved-input-value (2) of the first method for creating password (FIG. 1, method 100); comparing consistency of said pending-saved-input-value (4) and said saved-input-value (2); (S26) if said comparison is consistent, the verification is passed; and (S27) if said comparison is not consistent, the verification is failed. It is preferable that the success rate of brute-force attack is reduced by increasing time or resource cost because of using the asymmetric encryption algorithm.

4. Personal Data Decryption of the First Method for Verifying Password (FIG. 6, Method 200)

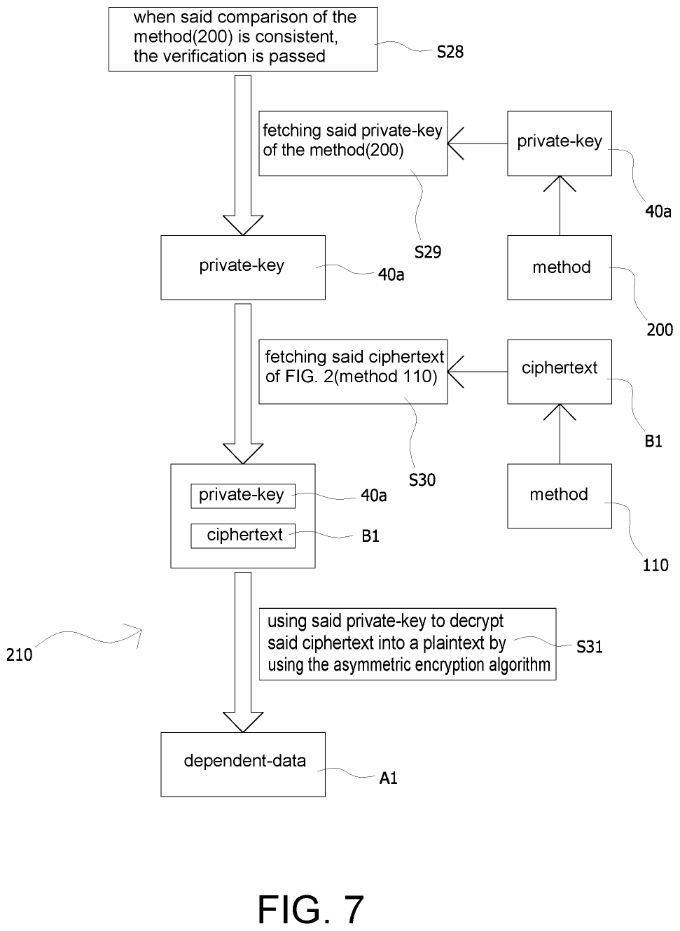

i. Using the Asymmetric Encryption Algorithm (FIG. 7, Method 210)

Please refer to FIG. 7, FIG. 7 is a flowchart illustrating the overall operation of personal data (e.g. Address) decryption of the first method for verifying password (FIG. 6, method 200) of the present invention. (S28) When said comparison of the first method for verifying password (FIG. 6, method 200) is consistent, the verification is passed; (S29) fetching said private-key (40a) of the first method for verifying password (FIG. 6, method 200); (S30) fetching said ciphertext (B1) of FIG. 2 (method 110); and (S31) using said private-key (40a) to decrypt said ciphertext (B1) into a plaintext by using the asymmetric encryption algorithm (e.g. Elliptic Curve Cryptography). Now, the personal data has been decrypted (plaintext). It is preferable that the password is used as a key to decrypt personal data individually.

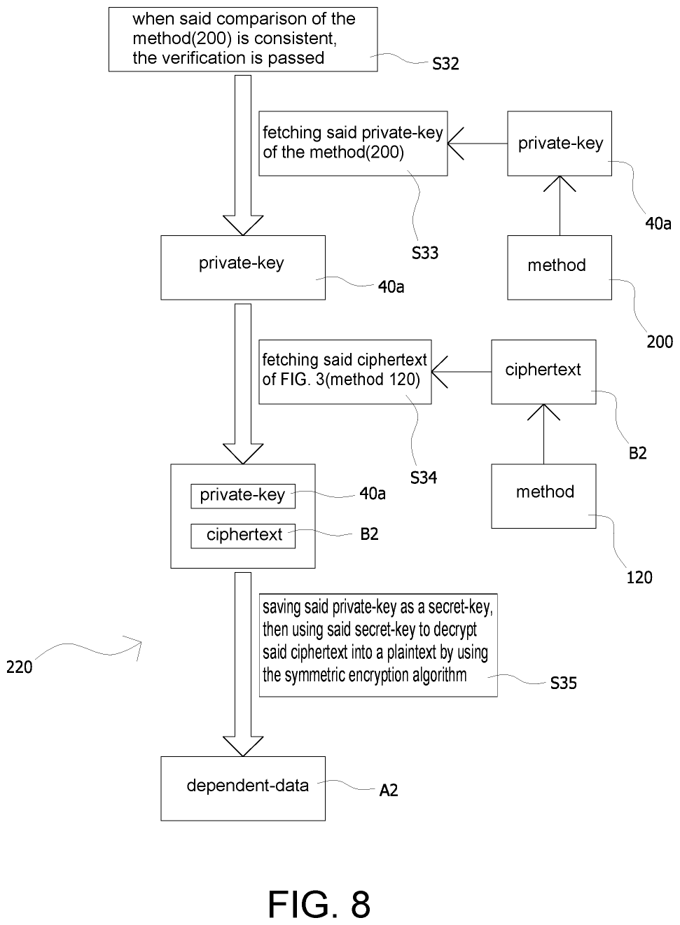

ii. Using the Symmetric Encryption Algorithm (FIG. 8, Method 220)

Please refer to FIG. 8, FIG. 8 is a flowchart illustrating the overall operation of personal data (e.g. Address) decryption of the first method for verifying password (FIG. 6, method 200) of the present invention. (S32) When said comparison of the first method for verifying password (FIG. 6, method 200) is consistent, the verification is passed; (S33) fetching said private-key (40a) of the first method for verifying password (FIG. 6, method 200); (S34) fetching said ciphertext (B2) of FIG. 3 (method 120); and (S35) saving said private-key (40a) as a secret-key (C2), then using said secret-key (C2) to decrypt said ciphertext (B2) into a plaintext by using the symmetric encryption algorithm (e.g. Advanced Encryption Standard). Now, the personal data has been decrypted (plaintext). It is preferable that the password is used as a key to decrypt personal data individually.

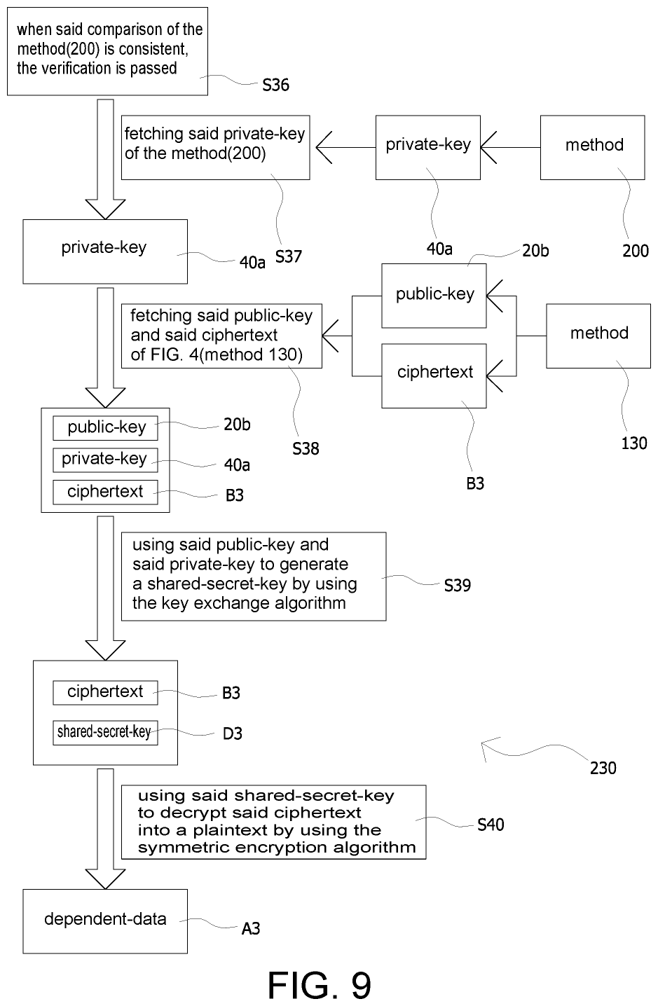

iii. A First Way to Allow System Administrators to Decrypt Personal Data (FIG. 9, Method 230)

Please refer to FIG. 9, FIG. 9 is a flowchart illustrating the overall operation of personal data (e.g. Address) decryption of the first method for verifying password (FIG. 6, method 200) of the present invention. (S36) When said comparison of the first method for verifying password (FIG. 6, method 200) is consistent, the verification is passed; (S37) fetching said private-key (40a) of the first method for verifying password (FIG. 6, method 200); (S38) fetching said public-key (20b) and said ciphertext (B3) of FIG. 4 (method 130); (S39) using said private-key (40a) and said public-key (20b) to generate a shared-secret-key (D3) by using the key exchange algorithm (Diffie-Hellman key exchange); and (S40) using said shared-secret-key (D3) to decrypt said ciphertext (B3) into a plaintext by using the symmetric encryption algorithm (e.g. Advanced Encryption Standard). Now, the personal data has been decrypted (plaintext). It is preferable that both system administrator and system user can decrypt the personal data individually.

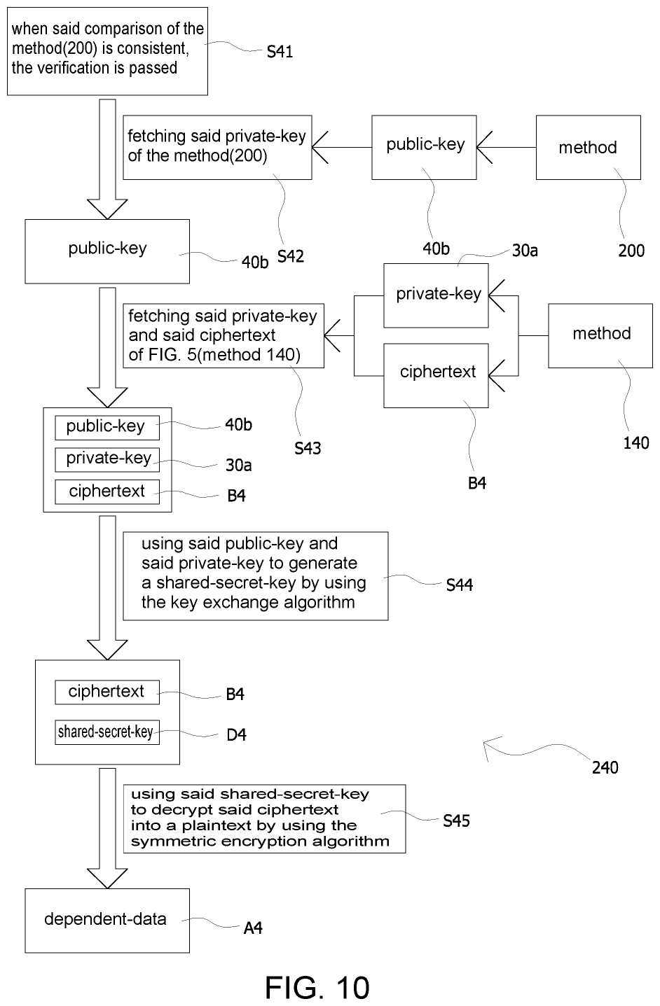

iv. A Second Way to Allow System Administrators to Decrypt Personal Data (FIG. 10, Method 240)

Please refer to FIG. 10, FIG. 10 is a flowchart illustrating the overall operation of personal data (e.g. Address) decryption of the first method for verifying password (FIG. 6, method 200) of the present invention. (S41) When said comparison of the first method for verifying password (FIG. 6, method 200) is consistent, the verification is passed; (S42) fetching said public-key (40b) of the first method for verifying password (FIG. 6, method 200); (S43) fetching said private-key (30a) and said ciphertext (B4) of FIG. 5 (method 140); (S44) using said public-key (40b) and said private-key (30a) to generate a shared-secret-key (D4) by using the key exchange algorithm (Diffie-Hellman key exchange); and (S45) using said shared-secret-key (D4) to decrypt said ciphertext (B4) into a plaintext by using the symmetric encryption algorithm (e.g. Advanced Encryption Standard). Now, the personal data has been decrypted (plaintext). It is preferable that both system administrator and system user can decrypt the personal data individually.

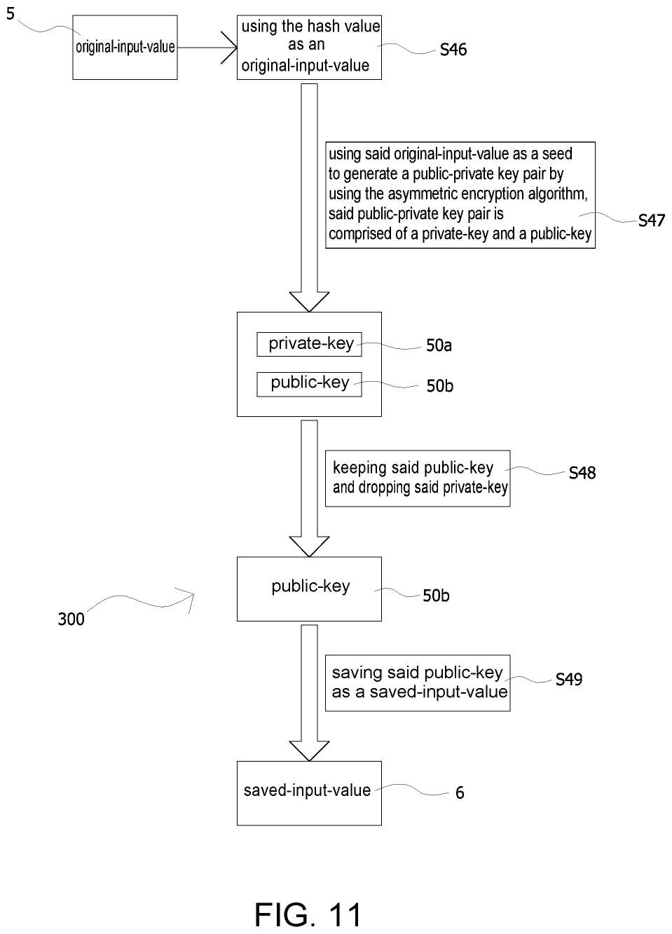

5. A Second Method for Creating Password (FIG. 11, Method 300)

Please refer to FIG. 11, FIG. 11 is a flowchart illustrating the overall operation of the input value (e.g. Password) creation of the present invention. When the system user inputs the password, it has been transformed into a hash value by using the hashing algorithm (e.g. Secure Hash Algorithm). (S46) Using the hash value as an original-input-value (5); (S47) using said original-input-value (5) as a seed to generate a public-private key pair by using the asymmetric encryption algorithm (e.g. Elliptic Curve Cryptography), said public-private key pair is comprised of a private-key (50a) and a public-key (50b); (S48) keeping said public-key (50b) and dropping said private-key (50a); and (S49) saving said public-key (50b) as a saved-input-value (6), the password (saved-input-value (6)) has been created. It is preferable that hardly reversing from hash value to plain text, fully compatible with current systems and does not require major system changes.

6. Personal Data Encryption of the Second Method for Creating Password (FIG. 11, Method 300)

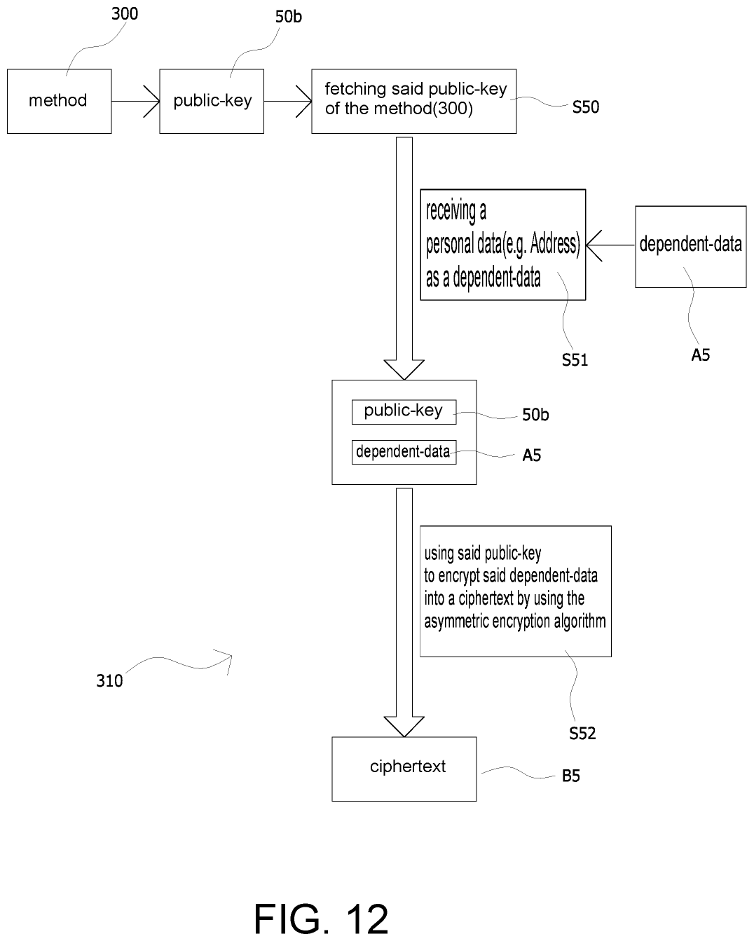

i. Using the Asymmetric Encryption Algorithm (FIG. 12, Method 310)

Please refer to FIG. 12, FIG. 12 is a flowchart illustrating the overall operation of personal data (e.g. Address) encryption of the second method for creating password (FIG. 11, method 300) of the present invention. (S50) Fetching said public-key (50b) of the second method for creating password (FIG. 11, method 300); (S51) receiving a personal data (e.g. Address) as a dependent-data (A5); and (S52) using said public-key (50b) to encrypt said dependent-data (A5) into a ciphertext (B5) by using the asymmetric encryption algorithm (e.g. Elliptic Curve Cryptography). Now, the personal data has been encrypted (ciphertext (B5)). It is preferable that the password is used as a key to encrypt personal data individually.

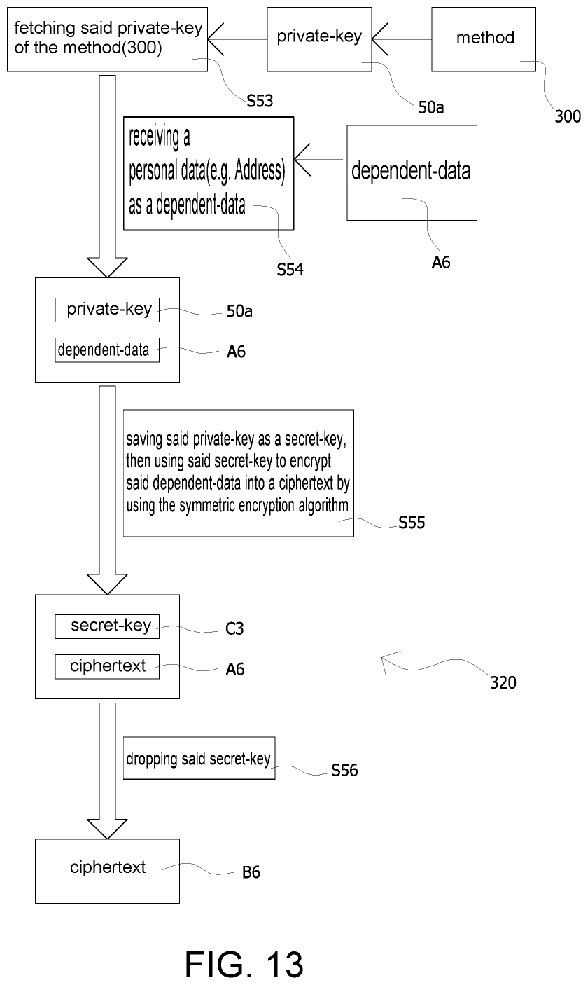

ii. Using the Symmetric Encryption Algorithm (FIG. 13, Method 320)

Please refer to FIG. 13, FIG. 13 is a flowchart illustrating the overall operation of personal data (e.g. Address) encryption of the second method for creating password (FIG. 11, method 300) of the present invention. (S53) Fetching said private-key (50a) of the second method for creating password (FIG. 11, method 300) before dropping it; (S54) receiving a personal data (e.g. Address) as a dependent-data (A6); (S55) saving said private-key (50a) as a secret-key (C3), and using said secret-key (C3) to encrypt said dependent-data (A6) into a ciphertext (B6) by using the symmetric encryption algorithm (e.g. Advanced Encryption Standard); and (S56) Dropping said secret-key (C3). Now, the personal data has been encrypted (ciphertext (B6)). It is preferable that the password is used as a key to encrypt personal data individually.

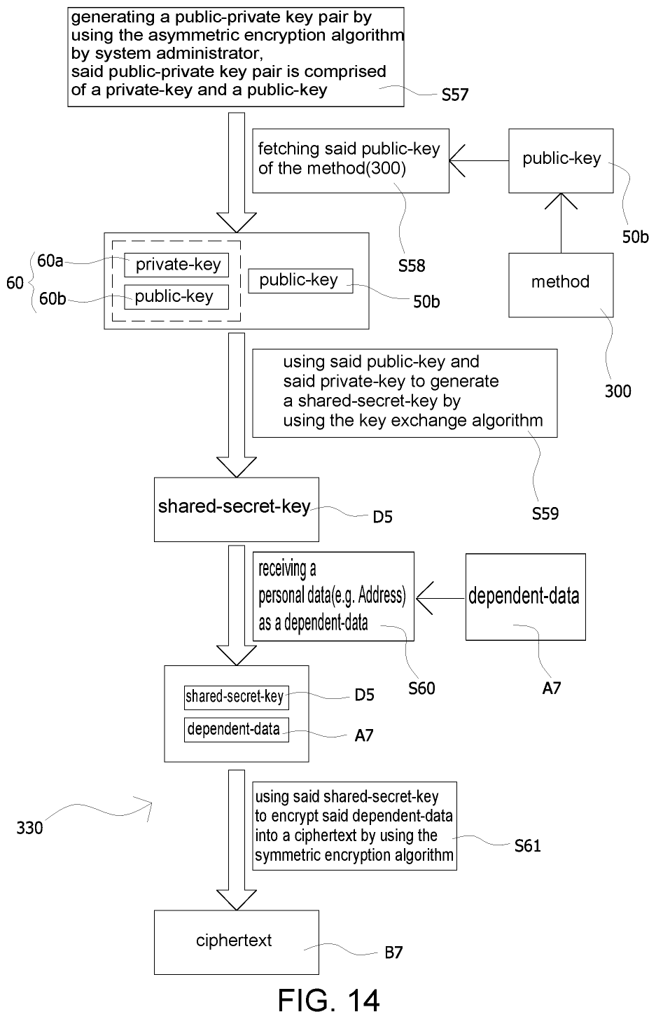

iii. A First Way to Allow System Administrators to Encrypt Personal Data (FIG. 14, Method 330)

Please refer to FIG. 14, FIG. 14 is a flowchart illustrating the overall operation of personal data (e.g. Address) encryption by system administrator of the second method for creating password (FIG. 11, method 300) of the present invention. (S57) Generating a public-private key pair (60) by using the asymmetric encryption algorithm (e.g. Elliptic Curve Cryptography) by system administrator, said public-private key pair (60) is comprised of a private-key (60a) and a public-key (60b); (S58) fetching said public-key (60b) of the second method for creating password (FIG. 11, method 300); (S59) using said public-key (60b) and said private-key (60a) to generate a shared-secret-key (D5) by using the key exchange algorithm (Diffie-Hellman key exchange); (S60) receiving a personal data (e.g. Address) as a dependent-data (A7); and (S61) using said shared-secret-key (D5) to encrypt said dependent-data (A7) into a ciphertext (B7) by using the symmetric encryption algorithm (e.g. Advanced Encryption Standard). Now, the personal data has been encrypted (ciphertext (B7)). It is preferable that both system administrator and system user can encrypt the personal data individually.

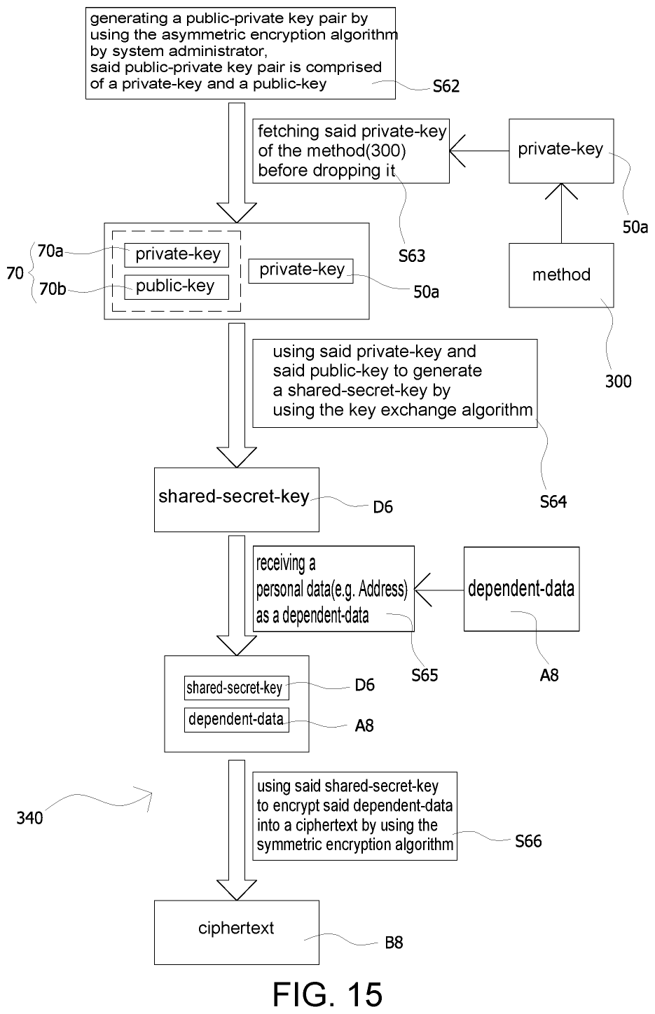

iv. A Second Way to Allow System Administrators to Encrypt Personal Data (FIG. 15, Method 340)

Please refer to FIG. 15, FIG. 15 is a flowchart illustrating the overall operation of personal data (e.g. Address) encryption by system administrator of the second method for creating password (FIG. 11, method 300) of the present invention. (S62) Generating a public-private key pair (70) by using the asymmetric encryption algorithm (e.g. Elliptic Curve Cryptography) by system administrator, said public-private key pair (70) is comprised of a private-key (70a) and a public-key (70b); (S63) fetching said private-key (50a) of the second method for creating password (FIG. 11, method 300) before dropping it; (S64) using said private-key (50a) and said public-key (70b) to generate a shared-secret-key (D6) by using the key exchange algorithm (Diffie-Hellman key exchange); (S65) receiving a personal data (e.g. Address) as a dependent-data (A8); and (S66) using said shared-secret-key (D6) to encrypt said dependent-data (A8) into a ciphertext (B8) by using the symmetric encryption algorithm (e.g. Advanced Encryption Standard). Now, the personal data has been encrypted (ciphertext (B8)). It is preferable that both system administrator and system user can encrypt the personal data individually.

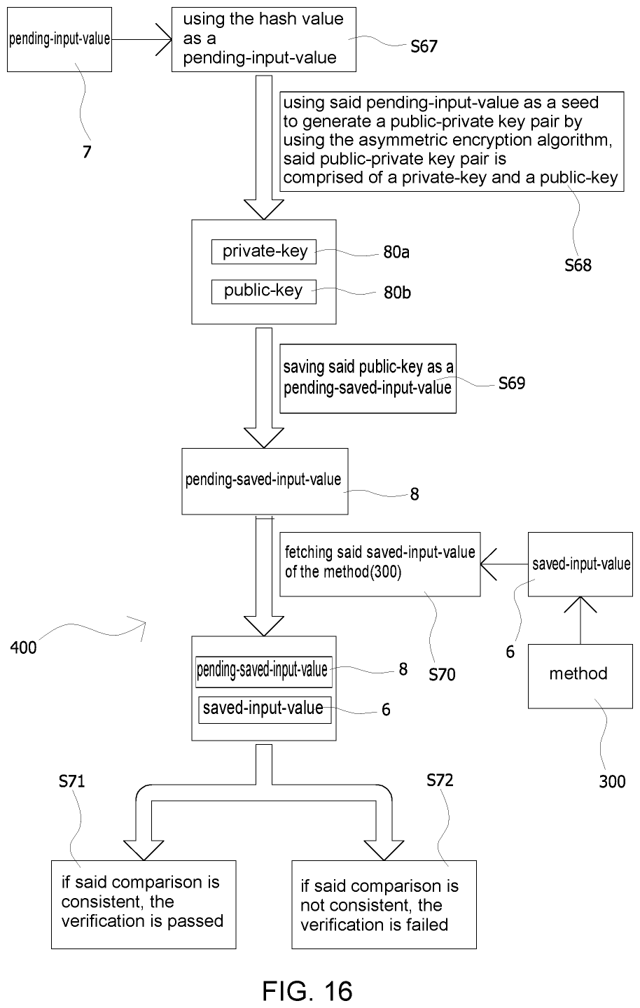

7. A Second Method for Verifying Password (FIG. 16, Method 400)

Please refer to FIG. 16, FIG. 16 is a flowchart illustrating the overall operation of the input value (e.g. Password) verification of the present invention. When the system user inputs the password for verification, it has been transformed into a hash value by using the hashing algorithm (e.g. Secure Hash Algorithm). (S67) Using the hash value as a pending-input-value (7); (S68) using said pending-input-value (7) as a seed to generate a public-private key pair by using the asymmetric encryption algorithm (e.g. Elliptic Curve Cryptography), said public-private key pair is comprised of a private-key (80a) and a public-key (80b); (S69) saving said public-key (80b) as a pending-saved-input-value (8); (S70) fetching said saved-input-value (6) of the second method for creating password (FIG. 11, method 300); comparing consistency of said pending-saved-input-value (8) and said saved-input-value (6); (S71) if said comparison is consistent, the verification is passed; and (S72) if said comparison is not consistent, the verification is failed. It is preferable that the success rate of brute-force attack is reduced by increasing time or resource cost because of using the asymmetric encryption algorithm.

8. Personal Data Decryption of the Second Method for Verifying Password (FIG. 16, Method 400)

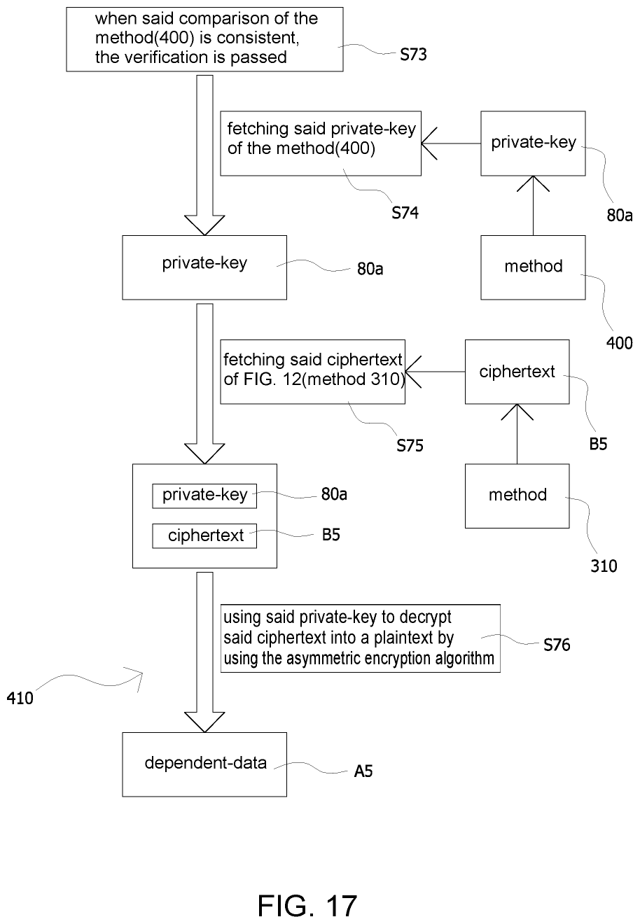

i. Using the asymmetric encryption algorithm (FIG. 17, method 410)

Please refer to FIG. 17, FIG. 17 is a flowchart illustrating the overall operation of personal data (e.g. Address) decryption of the second method for verifying password (FIG. 16, method 400) of the present invention. (S73) When said comparison of the second method for verifying password (FIG. 16, method 400) is consistent, the verification is passed; (S74) fetching said private-key (80a) of the second method for verifying password (FIG. 16, method 400); (S75) fetching said ciphertext (B5) of FIG. 12 (method 310); and (S76) using said private-key (80a) to decrypt said ciphertext (B5) into a plaintext by using the asymmetric encryption algorithm (e.g. Elliptic Curve Cryptography). Now, the personal data has been decrypted (plaintext). It is preferable that the password is used as a key to decrypt personal data individually.

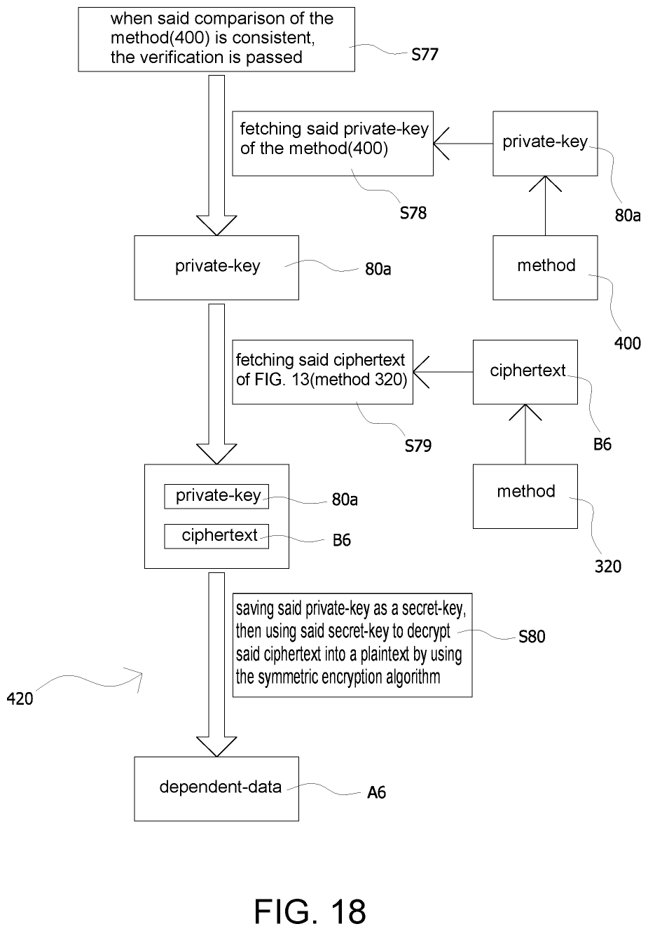

ii. Using the Symmetric Encryption Algorithm (FIG. 18, Method 420)

Please refer to FIG. 18, FIG. 18 is a flowchart illustrating the overall operation of personal data (e.g. Address) decryption of the second method for verifying password (FIG. 16, method 400) of the present invention. (S77) When said comparison of the second method for verifying password (FIG. 16, method 400) is consistent, the verification is passed; (S78) fetching said private-key (80a) of the second method for verifying password (FIG. 16, method 400); (S79) fetching said ciphertext (B6) of FIG. 13 (method 320); and (S80) saving said private-key (80a) as a secret-key (C4), and using said secret-key (C4) to decrypt said ciphertext (B6) into a plaintext by using the symmetric encryption algorithm (e.g. Advanced Encryption Standard). Now, the personal data has been decrypted (plaintext). It is preferable that the password is used as a key to decrypt personal data individually.

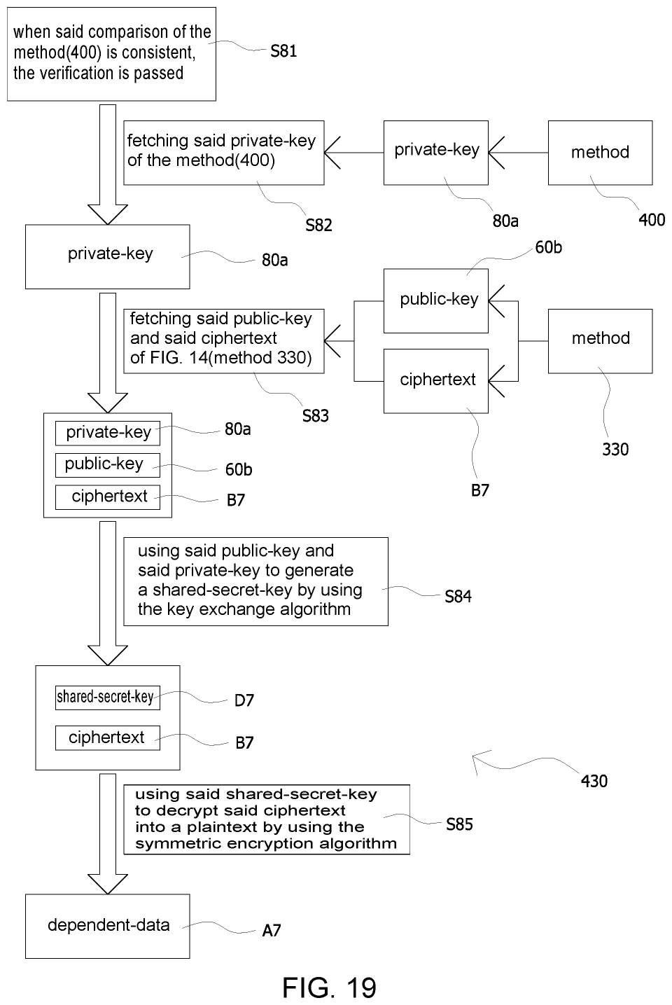

iii. A First Way to Allow System Administrators to Decrypt Personal Data (FIG. 19, Method 430)

Please refer to FIG. 19, FIG. 19 is a flowchart illustrating the overall operation of personal data (e.g. Address) decryption of the second method for verifying password (FIG. 16, method 400) of the present invention. (S81) When said comparison of the second method for verifying password (FIG. 16, method 400) is consistent, the verification is passed; (S82) fetching said private-key (80a) of the second method for verifying password (FIG. 16, method 400); (S83) fetching said public-key (60b) and said ciphertext (B7) of FIG. 14 (method 330); (S84) using said private-key (80a) and said public-key (60b) to generate a shared-secret-key (D7) by using the key exchange algorithm (Diffie-Hellman key exchange); (S85) using said shared-secret-key (D7) to decrypt said ciphertext (B7) into a plaintext by using the symmetric encryption algorithm (e.g. Advanced Encryption Standard). Now, the personal data has been decrypted (plaintext). It is preferable that both system administrator and system user can decrypt the personal data individually.

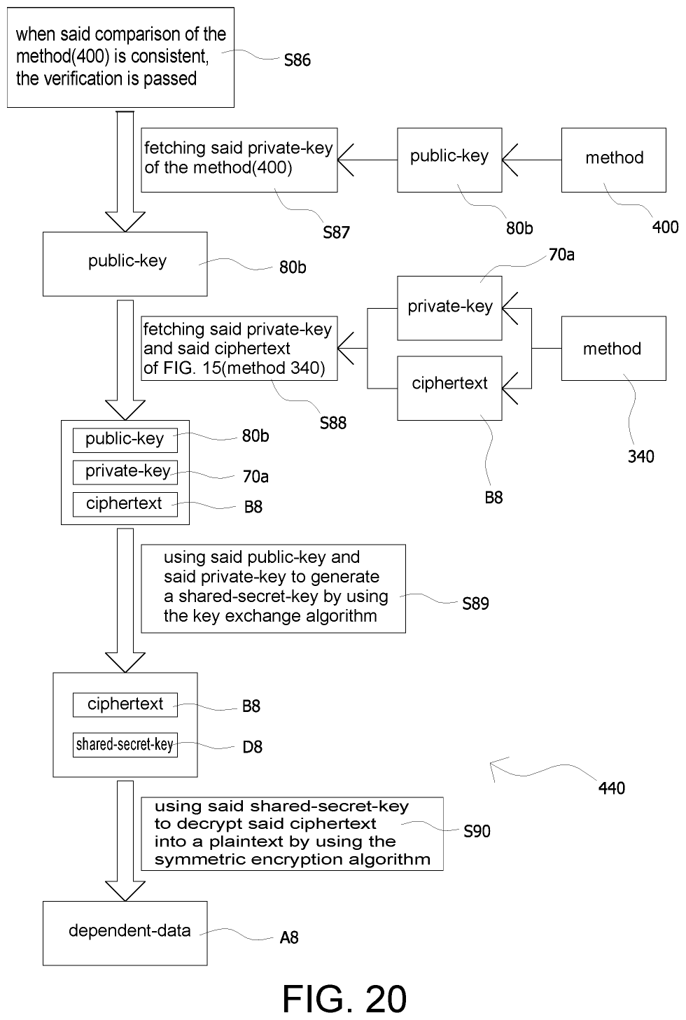

iv. A Second Way to Allow System Administrators to Decrypt Personal Data (FIG. 20, Method 440)

Please refer to FIG. 20, FIG. 20 is a flowchart illustrating the overall operation of personal data (e.g. Address) decryption of the second method for verifying password (FIG. 16, method 400) of the present invention. (S86) When said comparison of the second method for verifying password (FIG. 16, method 400) is consistent, the verification is passed; (S87) fetching said public-key (80b) of the second method for verifying password (FIG. 16, method 400); (S88) fetching said private-key (70a) and said ciphertext (B8) of FIG. 15 (method 340); (S89) using said public-key (80b) and said private-key (70a) to generate a shared-secret-key (D8) by using the key exchange algorithm (Diffie-Hellman key exchange); (S90) using said shared-secret-key (D8) to decrypt said ciphertext (B8) into a plaintext by using the symmetric encryption algorithm (e.g. Advanced Encryption Standard). Now, the personal data has been decrypted (plaintext). It is preferable that both system administrator and system user can decrypt the personal data individually.

The original-input-value (1, 5) and the pending-input-value (3, 7) of the present invention can be hash-value, key, plaintext, or ciphertext, and they can be represented as password or serial number.

It is also preferable to apply the above technology to operating system authentication, software serial number verification and other scenarios.

It is further preferable that the password is hardly reversing from hash value to plain text, and the personal data is also hardly be decrypted without key, even if the system is hacked.

9. Change Password

i. Remember Password

First, it must be authenticated by the method (FIG. 6 or FIG. 16) of the present invention; if personal data is encrypted, it must be decrypted first; a password is recreated by the method (FIG. 1 or FIG. 11) of the present invention to replace the old one; and the personal data is re-encrypted again by using the new password.

ii. Forget Password (Personal Data is not Encrypted)

A certain degree of identity verification must be performed according to the requirements first. After passing, the password can be reset directly.

iii. Forget Password (Personal Data is Encrypted)

A certain degree of identity verification must be performed according to the requirements first. After passing, for those who use shared key encryption, decrypt the personal data with the authority of the system administrator first, and then re-encrypt it after the password is reset. If the asymmetric or symmetric encryption algorithm is used, the encrypted personal data must be dropped first. After setting the password, reset a personal data and then encrypt it again.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

What is claimed is:

1. A method for creating input value by using an asymmetric encryption algorithm, comprising:
receiving an original-input-value;
using said original-input-value as a private-key to generate a public-key by using said asymmetric encryption algorithm;
keeping said public-key and dropping said private-key; and
saving said public-key as a saved-input-value.

2. The method of claim 1, wherein said original-input-value is a hash-value, a key, a plaintext, or a ciphertext, and said original-input-value is represented as a password or a serial number.

3. An application method according to the method of claim 1, comprising:
fetching said public-key of claim 1;
receiving a dependent-data; and
using said public-key to encrypt said dependent-data into a ciphertext by using said asymmetric encryption algorithm.

4. An application method according to the method of claim 1, comprising:
fetching said private-key of claim 1 before dropping said private-key;
saving said private-key as a secret-key;
receiving a dependent-data;
using said secret-key to encrypt said dependent-data into a ciphertext by using a symmetric encryption algorithm; and
dropping said secret-key.

5. An application method according to the method of claim 1, comprising:
generating a public-private key pair by using said asymmetric encryption algorithm from a system administrator, said public-private key pair comprised of a private-key and a public-key;
fetching said public-key of claim 1;
using said public-key and said private-key to generate a shared-secret-key by using a key exchange algorithm;
receiving a dependent-data; and
using said shared-secret-key to encrypt said dependent-data into a ciphertext by using a symmetric encryption algorithm.

6. A application method according to the method of claim 1, comprising:
generating a public-private key pair by using said asymmetric encryption algorithm from a system administrator, said public-private key pair comprised of a private-key and a public-key;
fetching said private-key of claim 1 before dropping said private-key;
using said private-key and said public-key to generate a shared-secret-key by using a key exchange algorithm;
receiving a dependent-data; and
using said shared-secret-key to encrypt said dependent-data into a ciphertext by using a symmetric encryption algorithm.

7. A method for verifying input value by using an asymmetric encryption algorithm, comprising:
receiving a pending-input-value;
using said pending-input-value as a private-key to generate a public-key by using said asymmetric encryption algorithm;
saving said public-key as a pending-saved-input-value;
fetching said saved-input-value of claim 1; and
comparing consistency of said pending-saved-input-value and said saved-input-value;
wherein if said comparison is consistent, a verification is passed, and if said comparison is not consistent, said verification is failed.

8. The method of claim 7, wherein said pending-input-value is a hash-value, a key, a plaintext, or a ciphertext, and said pending-input-value is represented as a password or a serial number.

9. A application method according to the method of claim 7, comprising:
when said comparison of claim 7 is consistent, said verification is passed;
fetching said private-key of claim 7;
fetching a ciphertext of claim 3; and
using said private-key to decrypt said ciphertext into a plaintext by using said asymmetric encryption algorithm.

10. An application method according to method of claim 7, comprising:
when said comparison of claim 7 is consistent, said verification is passed;
fetching said private-key of claim 7;
fetching a ciphertext of claim 4;
saving said private-key as a secret-key; and
using said secret-key to decrypt said ciphertext into a plaintext by using a symmetric encryption algorithm.

11. An application method according to the method of claim 7, comprising:
when said comparison of claim 7 is consistent, said verification is passed;
fetching said private-key of claim 7;
fetching a public-key and a ciphertext of claim 5;
using said private-key and said public-key to generate a shared-secret-key by using a key exchange algorithm; and
using said shared-secret-key to decrypt said ciphertext into a plaintext by using a symmetric encryption algorithm.

12. An application method according to the method of claim 7, comprising:
when said comparison of claim 7 is consistent, said verification is passed;
fetching said public-key of claim 7;
fetching a private-key and a ciphertext of claim 6;
using said public-key and said private-key to generate a shared-secret-key by using a key exchange algorithm; and
using said shared-secret-key to decrypt said ciphertext into a plaintext by using a symmetric encryption algorithm.

13. A method for creating input value by using an asymmetric encryption algorithm, comprising:
receiving an original-input-value;
using said original-input-value as a seed to generate a public-private key pair by using said asymmetric encryption algorithm, said public-private key pair comprised of a private-key and a public-key;
keeping said public-key and dropping said private-key; and
saving said public-key as a saved-input-value.

14. The method of claim 13, wherein said original-input-value is a hash-value, a key, a plaintext, or a ciphertext, and said original-input-value is represented as a password or a serial number.

15. An application method according to the method of claim 13, comprising:
fetching said public-key of claim 13;
receiving a dependent-data; and
using said public-key to encrypt said dependent-data into a ciphertext by using said asymmetric encryption algorithm.

16. An application method according to the method of claim 13, comprising:
fetching said private-key of claim 13 before dropping said private-key;
saving said private-key as a secret-key;
receiving a dependent-data;
using said secret-key to encrypt said dependent-data into a ciphertext by using a symmetric encryption algorithm; and
dropping said secret-key.

17. An application method according to the method of claim 13, comprising:
generating a public-private key pair by using said asymmetric encryption algorithm from a system administrator, said public-private key pair comprised of a private-key and a public-key;
fetching said public-key of claim 13;
using said public-key and said private-key to generate a shared-secret-key by using a key exchange algorithm;
receiving a dependent-data; and
using said shared-secret-key to encrypt said dependent-data into a ciphertext by using a symmetric encryption algorithm.

18. A application method according to the method of claim 13, comprising:
generating a public-private key pair by using said asymmetric encryption algorithm from a system administrator, said public-private key pair comprised of a private-key and a public-key;
fetching said private-key of claim 13 before dropping said private-key;
using said private-key and said public-key to generate a shared-secret-key by using a key exchange algorithm;
receiving a dependent-data; and
using said shared-secret-key to encrypt said dependent-data into a ciphertext by using a symmetric encryption algorithm.

19. A method for verifying input value by using an asymmetric encryption algorithm, comprising:
receiving a pending-input-value;
using said pending-input-value as a seed to generate a public-private key pair by using said asymmetric encryption algorithm, said public-private key pair comprised of a private-key and a public-key;
saving said public-key as a pending-saved-input-value;
fetching said saved-input-value of claim 13; and
comparing consistency of said pending-saved-input-value and said saved-input-value;
wherein if said comparison is consistent, a verification is passed, and if said comparison is not consistent, said verification is failed.

20. The method of claim 19, wherein said pending-input-value is a hash-value, a key, a plaintext, or a ciphertext, and said pending-input-value is represented as a password or a serial number.

21. A application method according to the method of claim 19, comprising:
when said comparison of claim 19 is consistent, said verification is passed;
fetching said private-key of claim 19;
fetching a ciphertext of claim 15; and
using said private-key to decrypt said ciphertext into a plaintext by using said asymmetric encryption algorithm.

22. An application method according to method of claim 19, comprising:
when said comparison of claim 19 is consistent, said verification is passed;
fetching said private-key of claim 19;
fetching a ciphertext of claim 16;
saving said private-key as a secret-key; and
using said secret-key to decrypt said ciphertext into a plaintext by using a symmetric encryption algorithm.

23. An application method according to the method of claim 19, comprising:
when said comparison of claim 19 is consistent, said verification is passed;
fetching said private-key of claim 19;
fetching said public-key and a ciphertext of claim 17;
using said private-key and said public-key to generate a shared-secret-key by using a key exchange algorithm; and
using said shared-secret-key to decrypt said ciphertext into a plaintext by using a symmetric encryption algorithm.

24. An application method according to the method of claim 19, comprising:
when said comparison of claim 19 is consistent, said verification is passed;
fetching said public-key of claim 19;
fetching said private-key and a ciphertext of claim 18;
using said public-key and said private-key to generate a shared-secret-key by using a key exchange algorithm; and
using said shared-secret-key to decrypt said ciphertext into a plaintext by using a symmetric encryption algorithm.
